(19) United States
(12) Patent Application Publication
(10) Pub. No.: US 2026/0007124 A1
(43) Pub. Date: Jan. 8, 2026

(54) Gaff With Bonker

(71) Applicant: Roger Gibson, Anchorage, AK (US)

(72) Inventor: Roger Gibson, Anchorage, AK (US)

(21) Appl. No.: 18/940,276

(22) Filed: Nov. 7, 2024

Related U.S. Application Data
(60) Provisional application No. 63/601,126, filed on Nov. 20, 2023.

(51) Int. Cl. A01K 97/14; B25G 1/04; B25G 3/26

(52) U.S. Cl. CPC A01K 97/14; B25G 1/04; B25G 3/26

(57) ABSTRACT

Representative implementations of devices and techniques provide a releasable bonker configured to be removably coupled to a modular handle. The modular handle can include a permanent or releasable gaff hook.

### PRIORITY CLAIM AND CROSS-REFERENCE TO RELATED APPLICATION

This application claims the benefit under 35 U.S.C. § 119(e)(1) of U.S. Provisional Application No. 63/601,126, filed Nov. 20, 2023, which is hereby incorporated by reference in its entirety.

### BACKGROUND

Fishing has been a ubiquitous activity for centuries, for sport, livelihood, and for survival. Fish are caught using a variety of rods and reels and from on the land or from in boats. Some anglers carry landing nets to remove their catch from the water. This helps keep fish from being damaged when using catch and release practices and it also can make it easier to land fish for keeping. However, many larger fish intended to be kept are more easily secured with a fishing gaff, such as the fishing gaff shown at FIG. 1. Larger fish may not fit well within a landing net or may escape the net or damage the net or themselves. A fishing gaff can be used to capture a fish so that it generally cannot escape. The fishing gaff is used to hook, spear, pierce, or otherwise penetrate the body of the fish to hold the fish securely.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

For this discussion, the devices and systems illustrated in the figures are shown as having a multiplicity of components. Various implementations of devices and/or systems, as described herein, may include fewer components and remain within the scope of the disclosure. Alternately, other implementations of devices and/or systems may include additional components, or various combinations of the described components, and remain within the scope of the disclosure. Shapes and/or dimensions shown in the illustrations of the figures are for example, and other shapes and or dimensions may be used and remain within the scope of the disclosure, unless specified otherwise.

FIG. 1 shows an example of a prior art fishing gaff.

FIG. 2 shows an example of a fishing gaff with a releasable bonker, according to an embodiment.

FIG. 3 shows an example releasable bonker, according to an embodiment.

FIG. 4 shows a cut-away view of a releasable bonker, according to an embodiment.

FIG. 5 shows a technique for coupling a releasable bonker to an example modular handle, according to an embodiment.

FIGS. 6A and 6B show additional techniques for coupling and releasing a releasable bonker to an example modular handle, according to an embodiment.

FIGS. 7A-7C show example releasable bonkers and modular handles according to various embodiments.

FIG. 8 shows an example releasable bonker configured to be coupled to an example modular T-handle, according to an embodiment.

FIG. 9 shows an example releasable bonker configured to be coupled to a telescoping handle, according to an embodiment.

FIG. 10 shows an example releasable bonker configured to be coupled to a modular handle and a handle extension and interchangeable tools configured to be coupled to the modular handle, according to an embodiment.

### DETAILED DESCRIPTION

### Overview

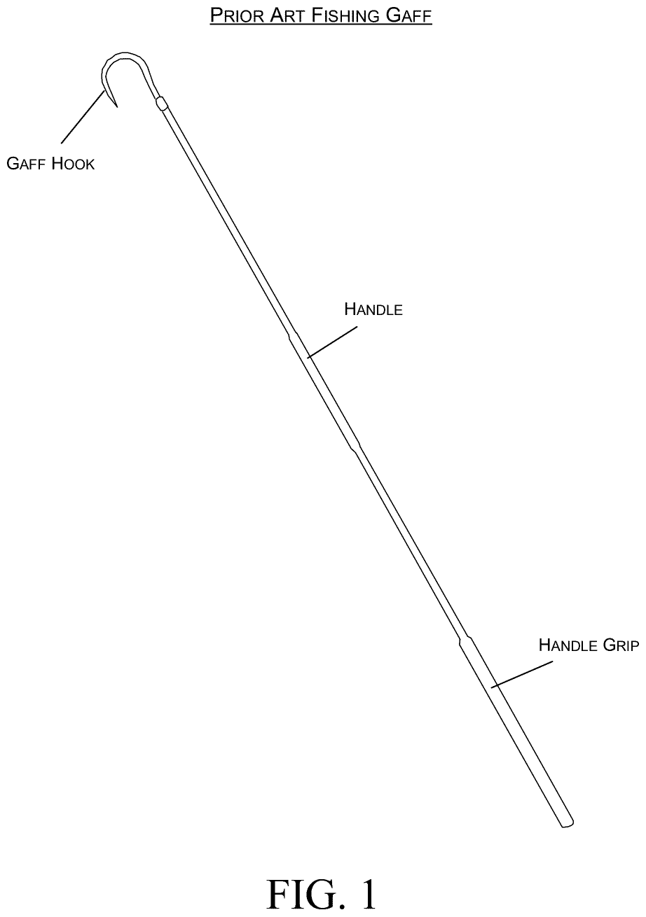

Referring to FIG. 1, an example fishing gaff is illustrated. The fishing gaff includes a gaff hook fixed to a handle and may also include one or more grips on the handle. The gaff hook can have a sharp point at the end of a curved hook and may be screwed onto the end of the handle, for example, to secure the hook to the handle. The handle may be a solid or hollow rod made of wood, metal, fiberglass, or other material. The grip, if present, may comprise a tape-wrapping or foam glued to the handle. The fishing gaff can be used to hook the body of a fish intended to be retained to prevent the fish from escaping.

Once a fish is captured by a fishing gaff, the angler still needs to subdue the fish if it is to be retained. For instance, larger species of fish can be heavy, strong, and hard to control. A bonker can be used to subdue the fish for easier handling. A bonker is a small club-like device that can be used by the angler to strike the fish (usually on the head of the fish), stunning the fish into submission so that it can be removed from the gaff and placed in cold storage, for example. Many objects have been used as bonkers, including sticks, rocks, or clubs. However, some anglers prefer to use commercially made bonkers, which can be designed for the specific purpose.

Some anglers carry a gaff and a bonker when fishing and may also carry a landing net. One or more of the items may be attached to the person or placed within reach. For instance, a bonker can be suspended from the person, on an item of clothing or gear for example. Although the bonker is available, it may be hard to access when it's needed and can also get in the way during the activity of fishing. Accordingly, the angler may not end up using the bonker or may not be able to use it efficiently or consistently.

Various aspects described herein may be commercialized as individual components and/or as a prepackaged kit. For example, a kit comprising a gaff with a releasable bonker may include a gaff handle and a releasable bonker that can be quickly released from and re-coupled to the handle. Various aspects described herein may also be modular. For example, the gaff handle may comprise a modular handle capable of receiving one or more extension handle sections and/or may include a quick-disconnect gaff hook. Other interchangeable quick-disconnect tools can be available to be coupled with the modular handle and may be included in a kit.

Based on the present disclosure, it will be understood that various advantages are provided by aspects described herein. Exemplary aspects hereof are described with reference to the figures, in which like elements are depicted with like reference numerals.

### Example Embodiments

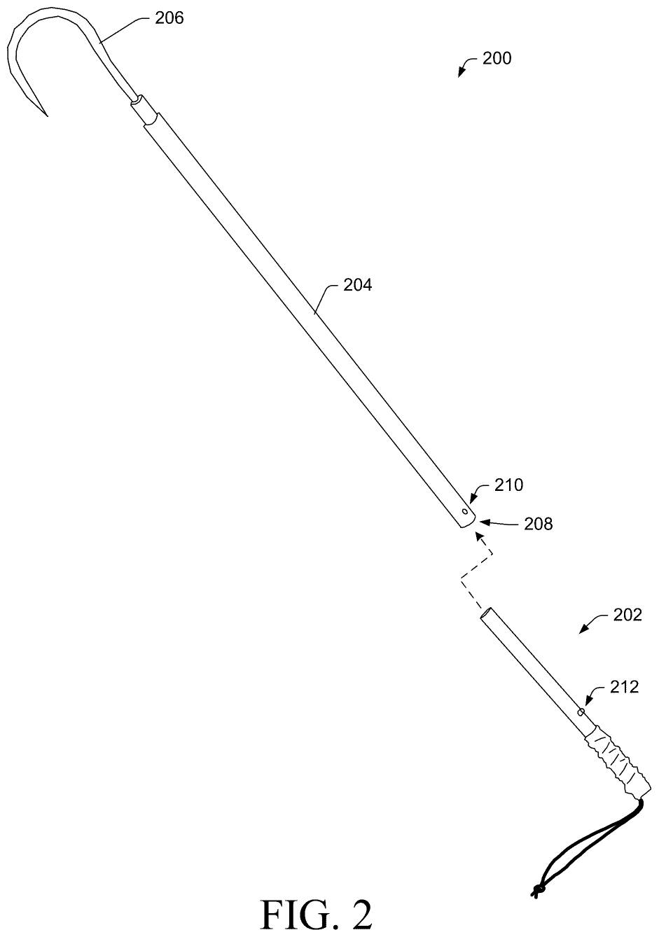

Referring to FIG. 2, representative embodiments of devices and techniques disclose a modular fishing gaff assembly 200. In an embodiment, the assembly 200 comprises a releasable bonker 202 configured to be removably coupled to a modular handle 204, which can include a permanent or releasable gaff hook 206. The releasable bonker 202 is removably coupled to one end of the handle 204 using one or more of various techniques and couplers. On the other end of the handle 204 (which can be any convenient length and is extendable in some embodiments) is a tool such as a gaff hook 206. In some embodiments, the gaff hook 206 is also releasable, and can be interchangeable with other tools configured to be coupled to the handle 204.

With the gaff hook 206 coupled to an end of the handle 204 and the releasable bonker 202 coupled to the opposite end of the handle 204, the fishing implement comprises a fishing gaff with a releasable bonker 202. This implementation allows an angler the advantage of holding a single implement with multiple functions. The angler can use the gaff hook 206 to capture a fish and then pull the releasable bonker 202 from the handle 204 to stun the fish without having to reach for a separate implement. Then, the releasable bonker 202 can be reinserted into the handle 204 for convenience.

Referring to FIGS. 2-5, an example releasable bonker 202 comprises a small club having a body 302 and a handle 304. Additionally, the releasable bonker 202 can include a lanyard 306 that can be worn around the wrist of the user, providing additional security against losing the releasable bonker 202 in the water. The lanyard 306 can also be used to attach the releasable bonker 202 to an object or an item of clothing or gear if desired.

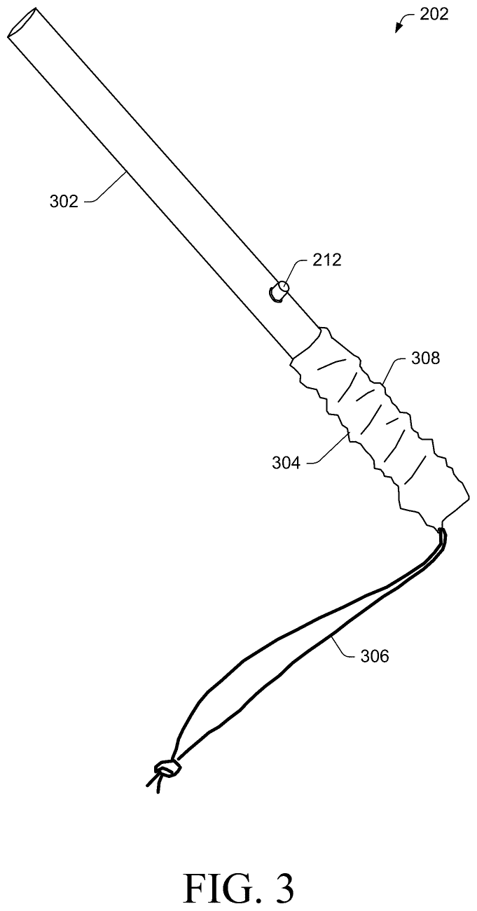

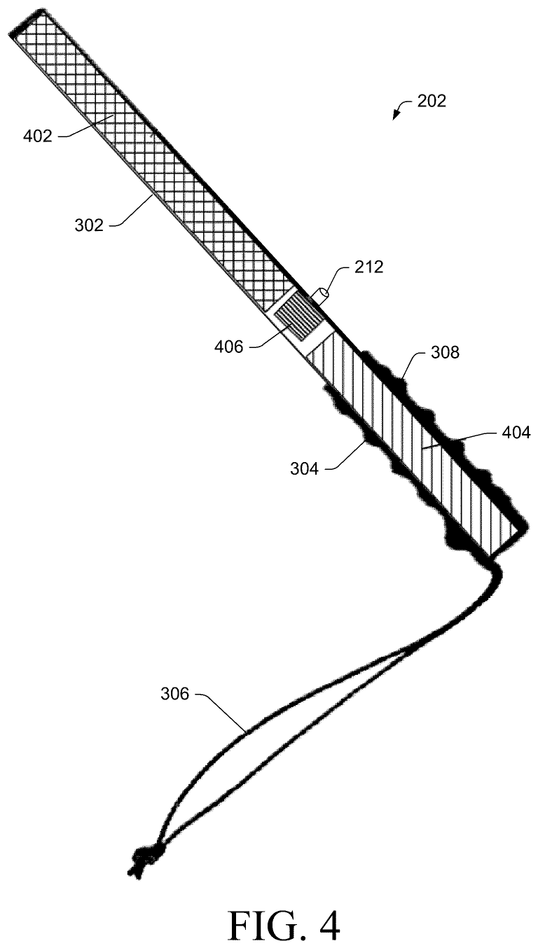

FIGS. 3 and 4 show details of an example releasable bonker 202. The releasable bonker 202 can be made available in various sizes (diameters and lengths) and various weights to suit the application and the user's preference. Accordingly, a number of differently sized and weighted releasable bonkers 202 may be interchangeably used with a single modular handle 204, by providing that each of the different releasable bonkers 202 can be coupled to the handle 204. This can include a cross-sectional size and shape of the body 302 of the bonker 202 that fits snugly inside the interior of the handle 204 and a properly located coupling mechanism (e.g., 208, 210, 212) to retain the releasable bonker 202 within the handle 204.

As shown in the cutaway illustration of FIG. 4, a releasable bonker 202 has a shaft portion 302 (body) that can include a weight 402 at the distal end or can be weighted at the distal end due to construction. For instance, a concentration of material can be disposed within the body 302 at the distal end of the body 302, which can comprise the material of the body 302, an added material, or a combination. The body 302 of the releasable bonker 202 can be made from solid and semi-solid rods as well as tubing of various materials (metals, alloys, plastics, carbon fiber, composites, etc.) and various thicknesses, diameters, and lengths. The weight 402 can include a weighted insert or fill comprising a metal, composite, aggregate, plastic, or other natural or artificial weighted material.

A grip 304 can be disposed at the proximal end of the shaft portion 302. The grip 304 can comprise a friction enhancing material such as a natural or synthetic rubber, a plastic, and the like, and can be disposed over the proximal end of the bonker body 302. The grip 304 may be glued or otherwise adhered to the body 302. Alternately, a discrete grip 304 can be coupled to the proximal end of the body 302 of the releasable bonker 202.

In some cases, the grip 304 includes features 308 that further improve the user's ability to securely hold onto the bonker 202 or use the bonker 202, such as ridges, grooves, patterns, and so forth. As shown in FIGS. 3 and 4, in some cases, the releasable bonker 202 includes an optional lanyard 306 at the grip-end of the releasable bonker 202, for example. Alternately, the lanyard 306 can be attached to the releasable bonker 202 at any convenient point on the releasable bonker 202.

As an option, the releasable bonker 202 can be made floatable by adding buoyancy or floatation material 404 into at least one end of the releasable bonker 202, such as the grip-end (i.e., proximal end) or elsewhere. Floatation material 404 can comprise and be added by placing light weight foam, or similar material, into at least a portion of the releasable bonker 202, as shown at FIG. 4. In this way, the buoyant portion of the releasable bonker 202 can float to the surface even while the weighted portion of the releasable bonker 202 may remain below the surface of the water. In some cases, the releasable bonker 202 can be made buoyant enough to prevent the fishing gaff assembly 200 from descending too far below the surface of the water while the releasable bonker 202 is coupled to the handle 204.

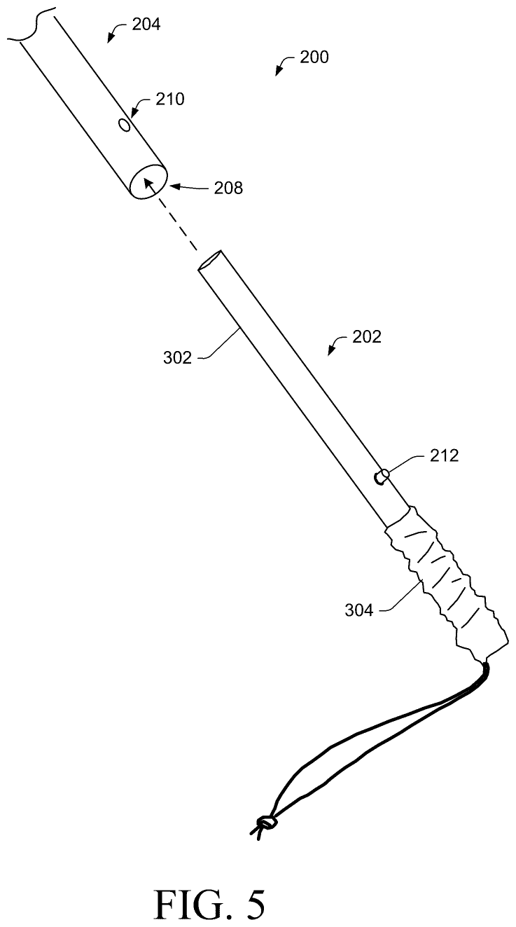

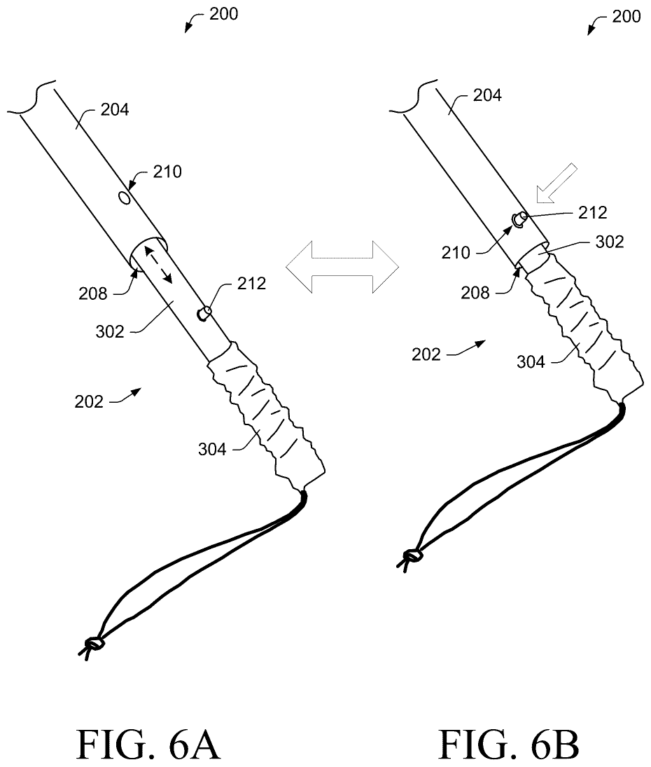

FIG. 5 is a prospective view of a releasable bonker 202 aligned to be coupled to a handle 204 of the fishing gaff assembly 200. Referring also to FIGS. 6A and 6B, in various embodiments, a portion of the body 302 of the releasable bonker 202 can be inserted into the end of the handle 204 to couple the releasable bonker 202 to the handle 204. In such an example, the end of the handle 204 includes a tube-like opening 208, comprising at least a portion of a tube with a larger diameter than the diameter of the bonker body 302. The body 302 of the releasable bonker 202 can be inserted into the opening 208 of the handle 204 and further into the handle 204 a predetermined distance. In various embodiments, the releasable bonker 202 can be secured into the handle 204 for retention during use of the fishing gaff, for example.

The releasable bonker 202 can be removably secured to the handle 204 using various coupling devices and techniques. For example, as shown at FIGS. 5-6B, the handle 204 can include a conveniently placed locking hole 210 (i.e., opening) and the releasable bonker 202 can include a tab or button or other type of release 212, which is arranged to engage the locking hole 210 when the releasable bonker 202 is inserted the predetermined distance. The release button 212 (and/or associated biasing) can be integral with the body 302 of the bonker 202 in some cases (such as when the release button 212 is a tab, or the like) or can be added to the interior of the body 302. In the latter case, the release button 212 can protrude from an opening in the body 302.

For example, referring also to FIG. 4, the releasable bonker 202 can include a biased (e.g., spring-loaded) button as the release button 212. The biasing of the release button 212 can be implemented using any of various biasing or spring devices or mechanisms 406. The biasing or spring device is generally in compression at all times, to push the release button 212 into an extended state (e.g., outward from the body 302). When the bonker 202 is being inserted into the handle 204, the biasing device 406 is further compressed or loaded (either manually by the user or as a result of inserting the bonker 202 into the handle 204), due to the release button 212 being pushed into the bonker body 302 to allow the bonker 202 to be inserted further into the handle 204. When the release button 212 encounters the locking hole 210, the biasing device 406 pushes the release button 212 outward and the release button 212 extends into the locking hole 210, securing the bonker 202 in the handle 204. With the releasable bonker 202 secured in the handle 204, the grip 304 of the bonker 202 can also be used as a grip for the fishing gaff assembly 200.

Referring again to FIGS. 6A and 6B, to release the releasable bonker 202 from the handle 204 for use as a bonker, the user grasps the bonker grip 304, presses the release button 212, and slides the bonker 202 out from the handle 204. As part of this process, the user depresses the release button 212 sufficiently through the locking hole 210 to allow the release button 212 to clear the locking hole 210. After using the bonker 202, the releasable bonker 202 can be replaced into the handle 204 as described above.

In other embodiments, the releasable bonker 202 may be coupled to the handle 204 using alternate coupling devices and techniques. For several examples, the coupling mechanism can comprise a clutch lock, a snap lock, a set knob, a cam lock, a tapered cone fitting, a twist lock, a pin lock, a screw-nut locking clamp, a lever locking clamp, a cotter pin coupling, a spring button clip in single or double configuration, a bayonet coupling, a standard screw-type coupling, a friction fitting, and so forth. In applicable configurations, the biasing device 406 may be present or not, and/or other mechanisms may be present as used for the coupling. Coupling mechanisms that are secure as well as easily engaged and disengaged (preferably with one hand) are desirable. In an alternate embodiment, the releasable bonker 202 includes a locking hole and the handle 204 includes a tab or button configured to engage the locking hole of the releasable bonker 202. Configurations with multiple locking buttons and multiple locking holes are also contemplated and are within the scope of the disclosure.

In various examples, the handle 204 can be a solid or semi-solid rod or can be one or more hollow tubes. Advantages of a solid or semi-solid rod can include the cost, strength, flexibility, and or durability of the rod, in some cases allowing the handle 204 to bend a certain amount (or not bend) without breaking. A solid or semi-solid handle 204 may be comprised of wood, plastic, metal, composite, and so forth. A semi-solid handle 204 may be partially filled with a material (such as a metal or the material of the handle 204) for added strength. Alternately, the handle 204 may be partially filled with a different material (such as a foam) for light weight and/or buoyancy. Advantages of a hollow tube handle 204 can include a combination of strength with light weight, depending on the material (aluminum or alloy, carbon fiber, composite, plastic, etc.).

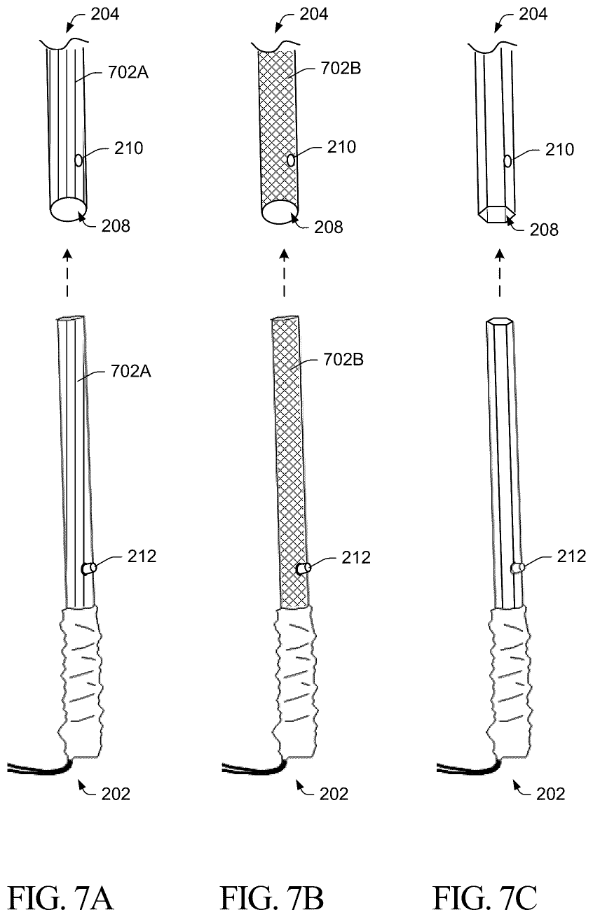

Referring to FIGS. 7A-7C, the cross-section of the handle 204 and the associated releasable bonker 202 may be cylindrical or elliptical (FIGS. 5, 7A, and 7B, for example), polygonal (FIG. 7C for example), irregular (not illustrated), or another shape. While the figures show some example cross-sectional shapes, other shapes are also contemplated and are within the scope of the disclosure. In one alternative, the handle 204 may be partly solid or semi-solid and partly a hollow tube (for instance at a coupling end 208 of the handle 204).

As also shown in FIGS. 7A-7C, in various examples the handle 204 and/or the releasable bonker 202 can have a texture 702 (or multiple textures 702) on its outer surface. The texture 702 can comprise an etched or cut pattern, such as the linear pattern 702A shown in FIG. 7A, the diamond pattern 702B shown in FIG. 7B, or various other patterns. In various embodiments, a texture 702 can provide additional grip for the user. For instance, the texture 702 can help the user to maintain a secure hold on the handle 204 or the bonker 202, even when either is wet.

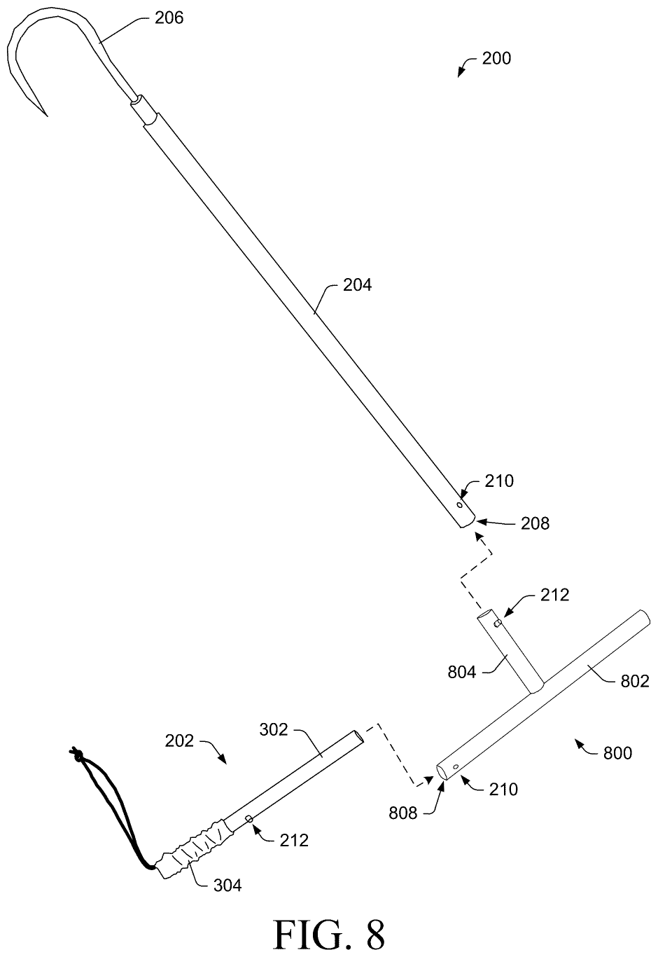

Referring to FIG. 8, in some examples, a modular fishing gaff assembly 200, including a releasable bonker 202 and a modular handle 204, may also include a modular T-handle 800 that can be used to couple the releasable bonker 202 to the modular handle 204 in an alternate arrangement. For example, the modular T-handle 800 can comprise two lengths or sections of rod or tubing 802 and 804, in any desired length, coupled together in a “T” formation (or at another desirable angle). For instance, the section 804 can protrude from the section 802 to form the T-handle 800.

At least the free end of the section 804 can be sized slightly smaller in diameter than the end 208 of the handle 204 to be inserted at least partway into the end 208 of the modular handle 204. The section 804 can include a release button 212 (or other coupling mechanism) that is positioned and arranged to engage the locking hole 210 in the modular handle 204 to secure the T-handle 800 to the modular handle 204. Then, the section 802 can be sized slightly larger in diameter than the body 302 of the bonker 202 so that the bonker 202 can be inserted at least partially into the section 802. The section 802 can include a locking hole 210 (or other coupling mechanism) that is positioned and arranged to be engaged by the release button 212 on the bonker 202 when the body 302 of the bonker 202 is inserted into one end 808 of the section 802.

Securing the T-handle 800 to the modular handle 204 forms a “T” connection with the handle 204, which can be convenient in some applications. For instance, when the gaff hook 206 is interchanged with a net, the T-handle 800 can be used advantageously to rotate the net during net fishing. The “T” handle, which can be gripped with both hands, can allow for greater control of the net, including the timing, degree, and torque applied to the net, as compared to a straight handle. Removing the T-handle 800 from the modular handle 204 is quick and easy: the angler depresses the release button 212 on the section 804 and slides the section 804 out of the end 208 of the handle 204.

The body 302 of the bonker 202 can be inserted into the section 802 of the T-handle 800 for easy storage and access to the bonker 202. With the bonker 202 secured within the T-handle 800, the angler has the bonker 202 at the ready. The grip 304 of the bonker 202 can be used to grip the T-handle 800 if desired. To release the bonker 202 from the T-handle 800, the release button 212 on the bonker 202 is depressed and the bonker 202 is slid out of the opening 808 of the section 802.

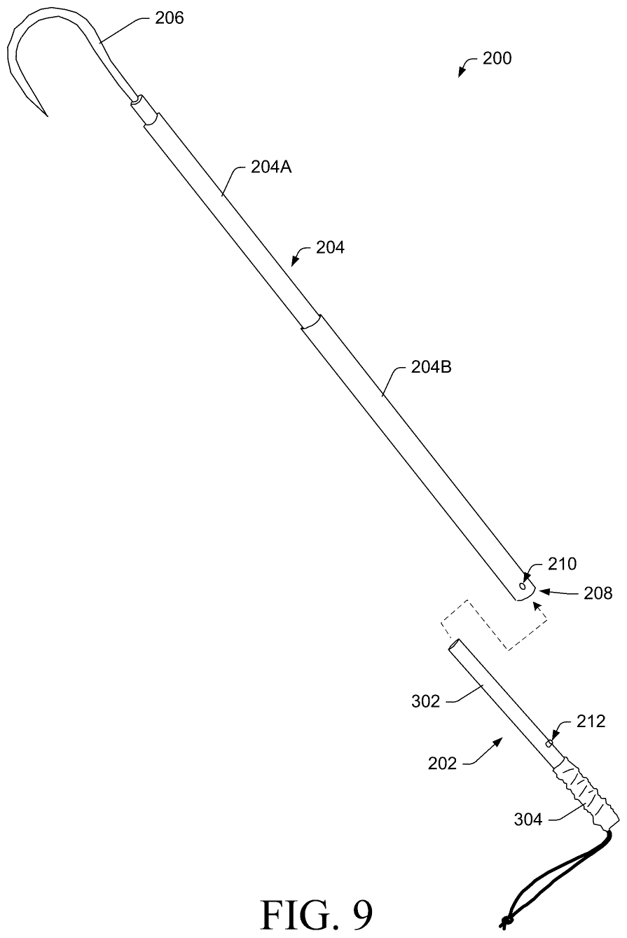

Referring to FIG. 9, in some embodiments, hollow tube handles 204 can be used to form telescoping handles 204 if desired. For instance, a larger diameter tube (204B) can be fitted over a smaller diameter tube (204A) to form a telescoping handle 204, with various techniques used to fix the telescoping tubes (204A and 204B) in a desired position for a desired length. Some techniques can include friction couplings (shower curtain rod type), holes and biased tabs/buttons (for one or more discrete positions), holes with traditional fasteners (such as nuts and bolts, etc.), and so forth. As shown at FIG. 9, telescoping handles 204 can also comprise modular handles 204, with all of the modular benefits described herein.

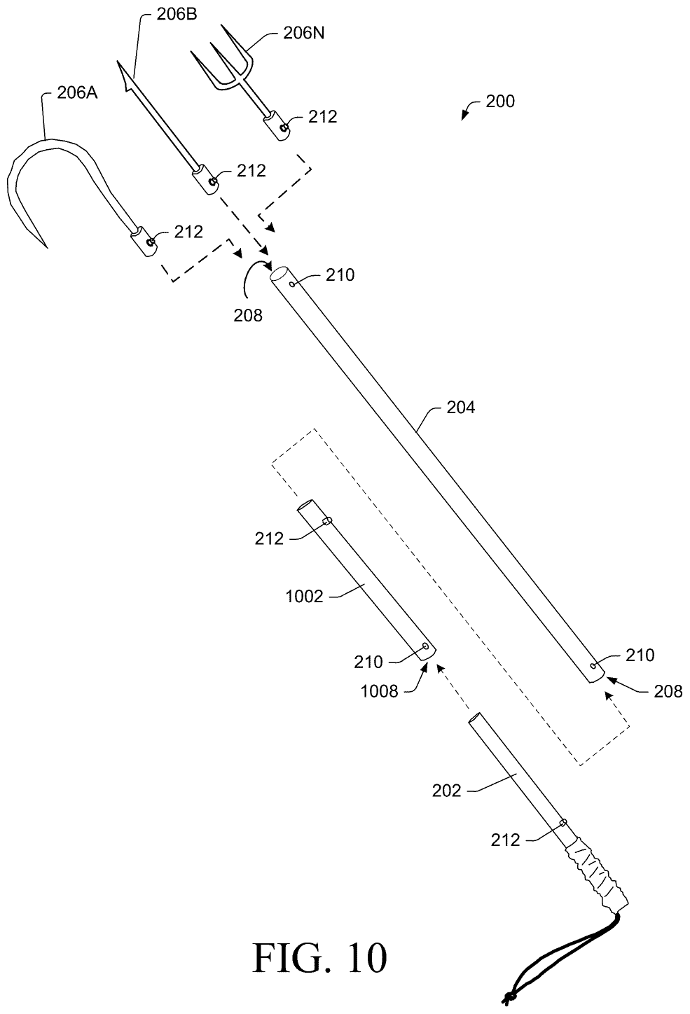

For example, in some embodiments as shown at FIG. 10, various interchangeable fish-piercing tools or accessories (such as the gaff hook 206) may be releasably coupled to the distal end of the handle 204. The handle 204 can comprise a modular handle 204 with a releasable coupling (e.g., opening 208 and locking hole 210, or other coupling) at each end of the handle 204. In such embodiments, the gaff hook 206 is also releasable/removable from the handle 204 in a modular fashion. The gaff hook 206 can be releasably coupled to the modular handle 204 by inserting the end of the gaff hook 206 into the opening 208 and engaging the locking button 212 on the gaff hook 206 with the locking hole 210 on the handle 204. Alternately, the gaff hook 206 can be releasably coupled to the modular handle 204 using one or more of various coupling techniques and couplers including traditional fasteners, releasable locking devices, bayonet couplings, and so forth.

In an example, the gaff hook 206 is releasably coupled to the handle 204 using one or more spring loaded buttons 212 or tabs that engage a feature such as a locking hole 210 or other opening in the handle 204. In various embodiments, the gaff hook 206 is releasable to replace or interchange the gaff hook 206A with one of various interchangeable fish-piercing tools or accessories (206A-206N), such as a spear 206B, a trident 206N, a barbed gaff hook or spear, a blade, and so forth. Additionally, a net, a deck brush, or other tool or accessory could also be interchangeable with the gaff hook 206. The corresponding tool or accessory can couple to the handle 204 using a similar releasable coupler as the gaff hook 206, or some other technique.

As also shown at FIG. 10, in some embodiments the modular handle 204 can include a removable extension handle 1002. The extension handle 1002 can be added to the handle 204 to extend the length of the handle 204 when desired. In various embodiments, the extension handle 1002 is coupled to the handle 204 in place of the releasable bonker 202, which is coupled to the end of the extension handle 902 instead. In the embodiments, the extension handle 1002 couples to the modular handle 204 in a like manner as the releasable bonker 202. For example, one end of the extension handle 1002 is inserted into the opening 208 in the end of the modular handle 204 and a biased locking button 212 on the extension handle 1002 engages the locking hole 210 in the handle 204. Then, if desired, the distal end of the releasable bonker 202 can be inserted into the opening 1008 of the extension handle 1002, engaging the locking button 212 of the releasable bonker 202 with the locking hole 210 of the extension handle 1002. Extension handles 1002 of various lengths can be formed and made available for convenience. Further, extension handles 1002 can be formed to have a cross-sectional shape and surface texture to match the modular handle 204, and can be made from the same materials as the handle 204 or different materials as desired.

Aspects of the present disclosure have been described with the intent to be illustrative rather than restrictive. Alternative aspects will become apparent to those skilled in the art that do not depart from its scope. A skilled artisan may develop alternative means of implementing the aforementioned improvements without departing from the scope of the present disclosure.

It will be understood that certain features and sub-combinations are of utility and may be employed without reference to other features and sub-combinations and are contemplated within the scope of the claims. Not all steps listed in the various figures need be carried out in the specific order described.

### Conclusion

Although the implementations of the disclosure have been described in language specific to structural features and/or methodological acts, it is to be understood that the implementations are not necessarily limited to the specific features or acts described. Rather, the specific features and acts are disclosed as representative forms of implementing the claims.

What is claimed is:

1. A fishing implement assembly, comprising:
a modular elongated handle having a releasable coupling at each end of the modular elongated handle;
a fish bonker releasably coupled to a first end of the modular elongated handle via a first releasable coupling; and
an interchangeable fish-piercing tool releasably coupled to a second end of the modular elongated handle via a second releasable coupling.

2. The fishing implement assembly of claim 1, further comprising an extension handle configured to be releasably coupled to the first end of the modular elongated handle via the first releasable coupling to extend a length of the modular elongated handle.

3. The fishing implement assembly of claim 2, wherein the fish bonker is configured to be releasably coupled to an end of the extension handle via a releasable coupling at the extension handle.

4. The fishing implement assembly of claim 2, wherein a portion of the fish bonker is configured to be inserted into an end of the extension handle.

5. The fishing implement assembly of claim 1, wherein a portion of the fish bonker is configured to be inserted into the first end of the modular elongated handle.

6. The fishing implement assembly of claim 1, wherein the modular elongated handle comprises a multi-section telescoping handle.

7. The fishing implement assembly of claim 1, wherein the interchangeable fish-piercing tool comprises one of a hook, a blade, a spear, and a trident.

8. An apparatus, comprising:
an elongated handle;
a fish bonker releasably coupled to a first end of the elongated handle, a portion of the fish bonker inserted into the first end of the elongated handle; and
a hook or blade disposed at a second end of the handle.

9. The apparatus of claim 8, further comprising an extension handle configured to be releasably coupled to the first end of the elongated handle to extend a length of the elongated handle, and further configured to receive the fish bonker at a second end of the extension handle.

10. The apparatus of claim 8, wherein the elongated handle comprises multiple hollow tube sections.

11. The apparatus of claim 8, further comprising a locking hole at the first end of the elongated handle, the locking hole comprising a coupling mechanism configured to interface with a button or tab on the fish bonker.

12. The apparatus of claim 11, further comprising a biased button or tab protruding from a surface of the fish bonker and arranged to engage the locking hole while the fish bonker is coupled to the elongated handle.

13. The apparatus of claim 12, wherein the biased button or tab protrudes from an opening in a body of the fish bonker, from within the body of the fish bonker.

14. The apparatus of claim 8, further comprising a weight disposed within a body of the fish bonker, at a first end of the fish bonker.

15. The apparatus of claim 8, further comprising floatation material disposed within the fish bonker, at a second end of the fish bonker.

16. The apparatus of claim 8, further comprising a T-handle configured to be releasably coupled to the elongated handle and releasably coupled to the fish bonker, the T-handle comprising a first tube section protruding from a second tube section, and wherein the first tube section is configured to be inserted into the elongated handle and the fish bonker is configured to be inserted into the second tube section.

17. The apparatus of claim 8, wherein the elongated handle includes a texture on an outer surface of the elongated handle, the texture including an etched or cut pattern.

18. The apparatus of claim 8, wherein the elongated handle includes a hollow tube at least at the first end of the elongated handle.

19. A modular fishing gaff, comprising:
a telescoping or extendable elongated handle having a releasable coupling at each end of the elongated handle, each releasable coupling including a locking hole;
a fish bonker configured to be removably coupled to a first end of the elongated handle by inserting at least a part of the fish bonker into the first end of the elongated handle and engaging a portion of the fish bonker with a first releasable coupling at the first end of the elongated handle; and
a gaff hook configured to be coupled to a second end of the elongated handle.

20. The modular fishing gaff of claim 19, wherein the gaff hook is configured to be releasably coupled to the second end of the elongated handle and is interchangeable with a plurality of fishing implements configured to be releasably coupled to the second end of the elongated handle.
